(19) United States
(12) Patent Application Publication
(10) Pub. No.: US 2025/0280204 A1
(43) Pub. Date: Sep. 4, 2025

(54) IMAGE PROCESSING APPARATUS AND METHOD, ELECTRONIC APPARATUS, AND STORAGE MEDIUM

(71) Applicant: CANON KABUSHIKI KAISHA, Tokyo (JP)

(72) Inventors: SHOJI YONEHATA, Kanagawa (JP); YASUYOSHI MIYAZAKI, Kanagawa (JP)

(21) Appl. No.: 19/052,846

(22) Filed: Feb. 13, 2025

(30) Foreign Application Priority Data
Feb. 29, 2024 (JP) 2024-030642
Jun. 27, 2024 (JP) 2024-104357

(51) Int. Cl. H04N 23/73; H04N 23/611; H04N 23/71

(52) U.S. Cl. CPC H04N 23/73; H04N 23/611; H04N 23/71

(57) ABSTRACT

An image processing apparatus comprises: an acquisition unit that acquires an image; a first detection unit that detects a first area showing a subject included in the image; a second detection unit that detects a second area having a predetermined first characteristic included in the image; a determination unit that determines a state of the subject; a calculation unit that calculates a photometric value using a luminance value of a first overlapping area in which the first area and the second area overlap in a case where the determination unit determines that the state of the subject satisfies a predetermined condition; and a decision unit that decides an exposure value based on the photometric value.

### BACKGROUND

### Technical Field

The aspect of the embodiments relates to an image processing apparatus and method, an electronic apparatus, and a storage medium, and more particularly to a method for determining a photometric value used for exposure control.

### Description of the Related Art

When performing exposure control in a digital camera or the like, a method is known in which an image captured for photometry is divided into grid-shaped blocks, the luminance value of each block is acquired, and exposure control is performed based on an evaluation value calculated from the average of the acquired luminance values. The brightness of the image of the scene to be captured can be kept appropriate by acquiring an exposure correction value that converges this evaluation value to an appropriate luminance, and by feeding it back to exposure control such as aperture, shutter, and ISO. Furthermore, a method is also known in which the face or head of a subject is detected, and an exposure correction value is calculated using the obtained detection area so that the face has an appropriate brightness. However, if the background and/or hair is included in the face detection area, the brightness may deviate from the appropriate brightness due to their influence.

Japanese Patent Laid-Open No. 2005-148915 proposes a mechanism for detecting pixels that indicate skin color in a subject detection area using skin color detection, and calculating an exposure correction parameter based on the luminance value of the detected pixels. This makes it possible to calculate an exposure correction value that can make the face area have an appropriate luminance.

However, even if skin color detection as described in Japanese Patent Laid-Open No. 2005-148915 is used, there is a possibility that exposure correction cannot be performed in the intended area. For example, clothes and tree trunks that are close to the skin color are likely to be erroneously detected. In addition, skin color is likely to be detected in areas such as the back of the head where the underlying skin is easily visible, and exposure may not be properly corrected.

In addition, when an appropriate exposure value for a subject is calculated using the area obtained by subject detection, the background or hair may be included in a detection frame due to variations in the position and size of the detection frame, as shown in FIG. 12A. In particular, when the frame is shifted in a scene in which the luminance varies, such as a backlit scene where the face is dark and the background is bright, the luminance of the dark face to be extracted and the luminance of the bright background in the same frame are mixed and averaged, resulting in a luminance value that is higher than expected. Thus, when the luminance value is calculated in a state where the frame is shifted from an appropriate position, the calculated luminance deviates from the target luminance, and an appropriate exposure value cannot be set. In addition, a similar shift occurs when an item such as a mask or sunglasses is included in the frame.

In contrast, when the exposure value is calculated for only the skin obtained by skin detection as shown in FIG. 12B, it is possible to avoid the deviation in brightness caused by the background and an item on the face. However, as shown in FIG. 12C, there is a concern that the area where the underlying skin is easily visible, such as the back of the head, is easily detected as skin, and that an appropriate exposure value cannot be set as in the case of using the subject detection result.

### SUMMARY

According to a first aspect of the embodiment, there is provided an image processing apparatus comprising at least one processor or circuit configured to function as: an acquisition unit that acquires an image a first detection unit that detects a first area showing a subject included in the image; a second detection unit that detects a second area having a predetermined first characteristic included in the image; a determination unit that determines a state of the subject; a calculation unit that calculates a photometric value using a luminance value of a first overlapping area in which the first area and the second area overlap in a case where the determination unit determines that the state of the subject satisfies a predetermined condition; and a decision unit that decides an exposure value based on the photometric value.

Further, according to a second aspect of the embodiment, there is provided an electronic apparatus comprising: an image processing apparatus comprising at least one processor or circuit configured to function as: an acquisition unit that acquires an image; a first detection unit that detects a first area showing a subject included in the image; a second detection unit that detects a second area having a predetermined first characteristic included in the image; a determination unit that determines a state of the subject; a calculation unit that calculates a photometric value using a luminance value of a first overlapping area in which the first area and the second area overlap in a case where the determination unit determines that the state of the subject satisfies a predetermined condition; and a decision unit that decides an exposure value based on the photometric value; an image shooting unit that shoots and outputs an image; and at least one processor or circuit configured to function as a control unit that controls exposure based on the exposure value decided by the decision unit.

Furthermore, according to a third aspect of the embodiment, there is provided an image processing method comprising: acquiring an image; detecting a first area showing a subject included in the image; detecting a second area having a predetermined first characteristic included in the image; determining a state of the subject; calculating a photometric value using a luminance value of a first overlapping area in which the first area and the second area overlap in a case where it is determined that the state of the subject satisfies a predetermined condition; and deciding an exposure value based on the photometric value.

Further, according to a fourth aspect of the embodiment, there is provided a non-transitory computer-readable storage medium, the storage medium storing a program that is executable by the computer, wherein the program includes program code for causing the computer to function as an image processing apparatus comprising: an acquisition unit that acquires an image; a first detection unit that detects a first area showing a subject included in the image; a second detection unit that detects a second area having a predetermined first characteristic included in the image; a determination unit that determines a state of the subject; a calculation unit that calculates a photometric value using a luminance value of a first overlapping area in which the first area and the second area overlap in a case where the determination unit determines that the state of the subject satisfies a predetermined condition; and a decision unit that decides an exposure value based on the photometric value.

Further features of the disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure, and together with the description, serve to explain the principles of the disclosure.

FIG. 1 is a block diagram illustrating a functional configuration of an image capturing apparatus according to a first embodiment.

FIG. 2 is a flowchart of shooting processing according to the first embodiment.

FIGS. 3A to 3D are diagrams explaining divided regions and luminance values according to the first embodiment.

FIG. 4 is a block diagram illustrating a functional configuration of an image capturing apparatus according to a second embodiment.

FIG. 5 is a flowchart of shooting processing according to the second embodiment.

FIGS. 6A and 6B are diagrams illustrating distribution histograms of brightness of the skin area and hair area of a profile face and a back of the head according to the second embodiment.

FIG. 7 is a diagram illustrating a method of detecting an angle of the face according to the first and second embodiments.

FIG. 8 is a diagram illustrating a method of detecting an item on the face according to the first and second embodiments.

FIG. 9 is a flowchart of shooting processing according to a third embodiment.

FIG. 10 is a flowchart explaining a method using a plurality of thresholds for determining an area size of a skin area according to the third embodiment.

FIG. 11 is a diagram explaining a method using a plurality of thresholds for determining an area size of a skin area according to the third embodiment.

FIGS. 12A to 12C are diagrams for explaining problems in the conventional technology.

### DESCRIPTION OF THE EMBODIMENTS

Hereinafter, embodiments will be described in detail with reference to the attached drawings. Note, the following embodiments are not intended to limit the scope of the disclosure, and limitation is not made to a disclosure that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### Configuration of Image Capturing Apparatus

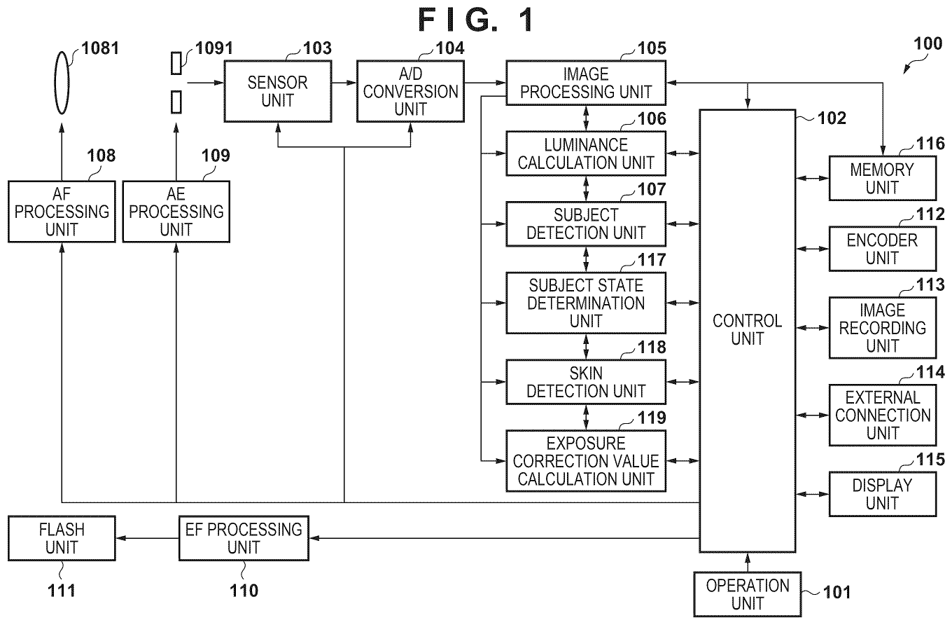

FIG. 1 is a block diagram showing the functional configuration of an image capturing apparatus 100 according to the first embodiment.

The configuration shown as blocks in FIG. 1 can be realized by an integrated circuit (IC) such as an ASIC or FPGA, by a discrete circuit, or by a combination of a memory and a processor that executes a program stored in the memory. In addition, one block may be realized by a plurality of integrated circuit packages, or a plurality of blocks may be realized by one integrated circuit package. The same block may also be implemented in different configurations depending on the operating environment, required capabilities, etc.

In the exemplary embodiments, a digital camera is described as an example. However, the aspect of the embodiments can be applied to various kinds of electronic devices. Such electronic devices include image capturing apparatuses, computer devices (personal computers, tablet computers, media players, PDAs, etc.), mobile phones, smartphones, game machines, robots, drones, dashboard cameras, etc. Note that these are merely examples, and the aspect of the embodiments can also be implemented in other electronic devices.

An operation unit 101 is composed of various operation members such as switches and buttons that an operator of the image capturing apparatus 100 operates to input various instructions, and includes a shutter switch and a touch sensor (which can be operated by touching a display device). Note that the shutter switch includes, for example, SW1 that is turned ON in response to a half-way operation (e.g., half-pressing) and instructs preparation for shooting, and SW₂ that is turned ON when the operation is completed (e.g., full pressing) and instructs the start of a series of shooting processing.

A control unit 102 includes a CPU, non-volatile memory, and RAM, and can realize various functions by the CPU executing programs stored in the non-volatile memory. For example, the control unit 102 controls the operation of each unit shown in FIG. 1 in response to instructions from the operation unit 101.

A sensor unit 103 receives light incident via an optical system including a lens 1081 and a mechanical system 1091 such as a diaphragm, and outputs an analog image signal obtained by converting the light into an electric charge according to the amount of the incident light. The sensor unit 103, lens 1081, and mechanical system 1091 constitute an imaging unit.

An A/D conversion unit 104 performs sampling, gain adjustment, A/D conversion, etc. on the analog image signal output from the sensor unit 103, and outputs the resulting digital image signal.

An image processing unit 105 performs various image processing on the digital image signal output from the A/D conversion unit 104, and outputs a processed digital image signal (image data). For example, the image processing unit 105 converts the digital image signal output from the A/D conversion unit 104 into a YUV image signal and outputs it.

A luminance calculation unit 106 calculates luminance using the image data output from the image processing unit 105, and calculates the difference between the calculated luminance and an appropriate luminance.

A subject detection unit 107 detects a subject in an image using the image data obtained from the image processing unit 105. The subject detected here is assumed to be a person, and the area of the subject's face and head in the image is obtained. For subject detection, known methods can be used, such as a method of extracting an area from the contour shape of a human body by pattern matching, a method of detecting important organs with characteristics such as eyes, nose, and mouth and detecting the head area including them, and a method using an algorithm that learns the face area of a person by machine learning. For example, in a method using machine learning, concepts of each granularity from the overall image of the subject to the details are associated as a hierarchical structure and learned. When learning people, images of people of various races, ages, sexes, face directions, and hair are used for learning. In addition to the face, the detection area can also be divided sections such as the head, torso, limbs, upper body, lower body, and whole body.

A subject state determination unit 117 determines the state of the face of the subject detected by the subject detection unit 107. The state of the face to be determined here includes, for example, the up/down/left/right orientation of the face, the presence or absence of hair or beard, and the presence or absence of items such as a mask or sunglasses.

A skin detection unit 118 detects skin in an image and acquires a skin area. For skin detection, known methods can be used, such as a method of extracting an area having a color gamut within a predetermined range defined as skin color, or a method using an algorithm that has learned the skin area by machine learning. For example, in a method using machine learning, concepts of each granularity from the overall image of the subject to the details are associated as a hierarchical structure and learned. When learning skin, by using images of people of various races, ages, and sexes, it becomes possible to detect skin even if there are differences in the shade of skin color between people.

A display unit 115 is configured with a liquid crystal display or the like, and displays an image based on the digital image signal output from the A/D conversion unit 104.

An external connection unit 114 is a connection unit for connecting an external monitor, a personal computer, etc. For example, by connecting an external monitor via the external connection unit 114, it becomes possible to display the image displayed on the display unit 115 on the external monitor.

An AF processing unit 108 obtains the focus state based on the image data output from the image processing unit 105, and controls the lens 1081 to adjust the focus.

An AE processing unit 109 controls the mechanical system 1091 based on the difference between the luminance calculated by the luminance calculation unit 106 using the image data output from the image processing unit 105 and the appropriate luminance. In this controls, for example, the aperture value and the shutter speed are controlled. The AE processing unit 109 may also be configured to control the gain used in the gain adjustment performed in the A/D conversion unit 104. Further, if the sensor unit 103 has an electronic shutter function, the shutter speed may be controlled by controlling the charge accumulation period of the sensor unit 103.

Furthermore, the AE processing unit 109 may determine whether or not to cause a flash unit 111 to emit light based on the difference in luminance, and if it is determined that the flash unit 111 should emit light, it may issue a light emission instruction to an EF processing unit 110. The determination of light emission and the light emission instruction may be performed by the control unit 102 in cooperation with the AE processing unit 109.

If it is determined that the flash unit 111 should emit light, the EF processing unit 110 causes the flash unit 111 to emit light in an amount that will make the brightness of the subject appropriate in accordance with the light emission instruction.

An encoder unit 112 converts the format of the image data output from the image processing unit 105 into a format such as JPEG and outputs the converted image data to an image recording unit 113.

The image recording unit 113 performs processing to record the format-converted image data output from the encoder unit 112 in a memory (not shown) within the image capturing apparatus 100 or an external memory (not shown) inserted in the image capturing apparatus 100.

A memory unit 116 temporarily stores image data being processed by the control unit 102, the image processing unit 105, the encoder unit 112, etc.

An exposure correction value calculation unit 119 calculates an exposure correction value based on the determination result of the subject state determination unit 117 using an image signal of an area where the subject area (face area or head area) detected by the subject detection unit 107 and the skin area detected by the skin detection unit 118 overlap.

The image processing unit 105, the luminance calculation unit 106, the subject detection unit 107, the subject state determination unit 117, the skin detection unit 118, and the exposure correction value calculation unit 119 may each be realized by a processor executing software, or may be realized by dedicated hardware. Also, the image processing unit 105, the luminance calculation unit 106, the subject detection unit 107, the subject state determination unit 117, the skin detection unit 118, and the exposure correction value calculation unit 119 are shown as being configured separately from the control unit 102, but are not limited to this. At least some of the functions of the image processing unit 105, the luminance calculation unit 106, the subject detection unit 107, the subject state determination unit 117, the skin detection unit 118, and the exposure correction value calculation unit 119 may be included in the control unit 102. In that case, the functions included in the control unit 102 are realized, for example, by a CPU executing a program stored in a non-volatile memory.

### Exposure Control

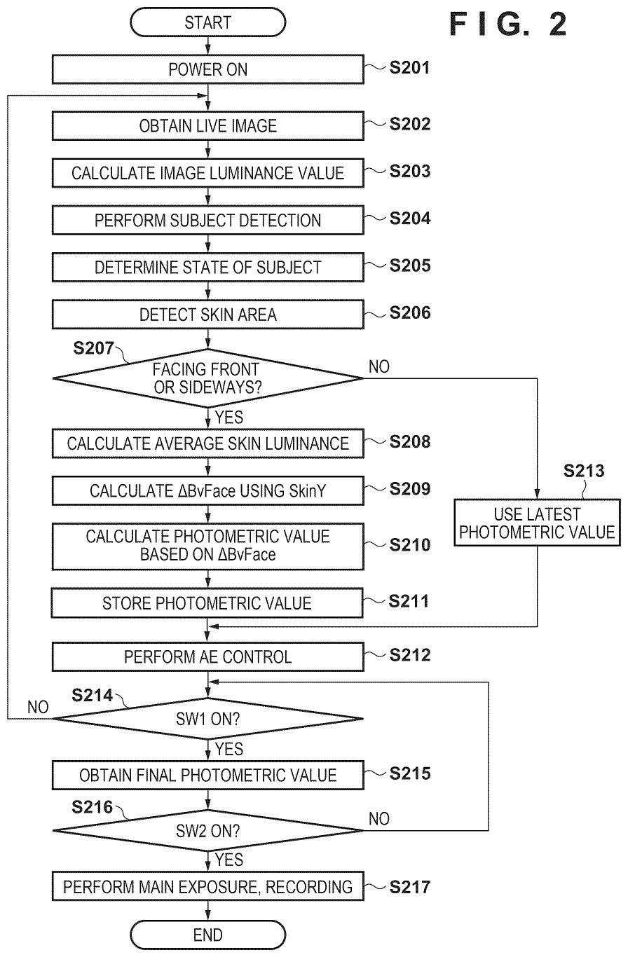

Next, exposure control in the first embodiment in the image capturing apparatus 100 having the above configuration will be described along with the flow of a shooting operation with reference to the flowchart of FIG. 2.

First, in step S201, when an operator of the image capturing apparatus 100 turns on a power switch included in the operation unit 101, the control unit 102 detects this and starts supplying power to each component of the image capturing apparatus 100.

When power is supplied to each component of the image capturing apparatus 100, a shutter opens in step S202, and light is incident on the sensor unit 103 via the lens 1081 and mechanical system 1091 arranged on the front of the camera. The sensor unit 103 reads out charges accumulated by photoelectric conversion according to the amount of incident light, and outputs an analog image signal corresponding to the charges to the A/D conversion unit 104.

The A/D conversion unit 104 performs sampling, gain adjustment, A/D conversion, etc. on the analog image signal output from the sensor unit 103 and outputs a digital image signal. The image processing unit 105 performs various image processing on the digital image signal output from the A/D conversion unit 104 and outputs a processed digital image signal (hereinafter referred to as a “live image”).

Next, in step S203, the luminance calculation unit 106 calculates the luminance value (image luminance value) of the entire live image output from the image processing unit 105. In this embodiment, first, the entire image is divided into grid-shaped blocks, and the luminance value of each block is calculated by averaging the luminance values of the pixels for each block. Then, the calculated luminance value of each block is multiplied by a weighting factor determined in advance for each block to calculate the average luminance value, which is the image luminance value.

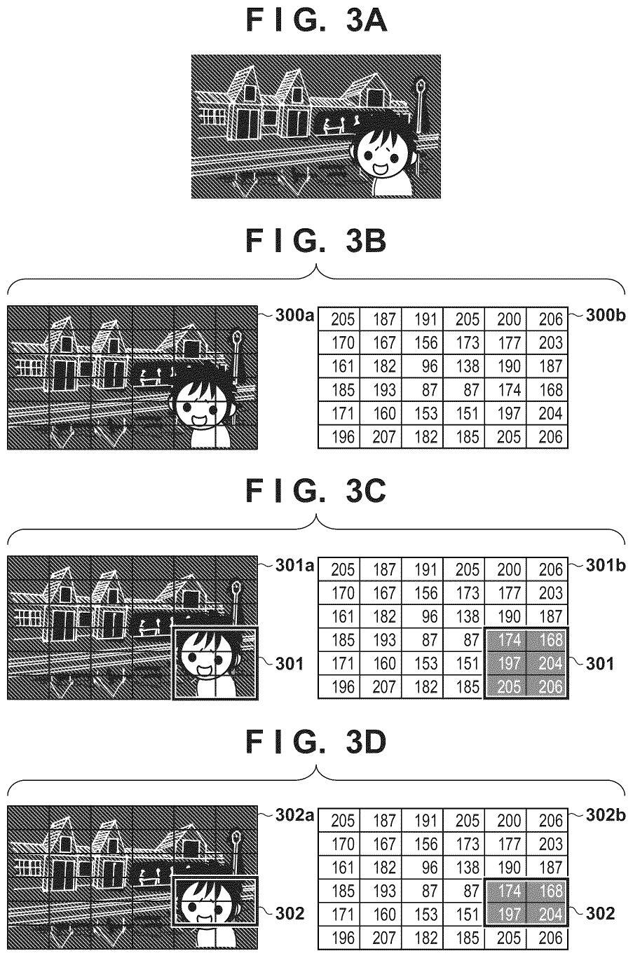

The image luminance value calculated here will be explained with reference to FIGS. 3A and 3B.

FIG. 3A shows an example of a live image output from the image processing unit 105. An image 300a in FIG. 3B shows an example of the live image shown in FIG. 3A divided into blocks, and a table 300b in FIG. 3B shows an example of luminance values of each block shown in the image 300a in FIG. 3B. The image luminance value is obtained by weighting and adding the luminance of each block shown in the table 300b in FIG. 3B.

Next, in step S204, the subject detection unit 107 detects a subject. Here, a person is detected in the live image, and the face or head area of the person is detected as the subject.

Next, in step S205, the state of the subject is determined by the subject state determination unit 117. The state of the subject determined here indicates the face area, the whole body area, the face direction, the presence and type of items such as a mask or sunglasses on the face, the presence or absence and color of hair, the presence or absence of beard, etc. In this embodiment, the subject state determination unit 117 obtains information on important organs such as the eyes, nose, and mouth from the face area detected by the subject detection unit 107, and determines the direction of the face based on where they are located in the face area.

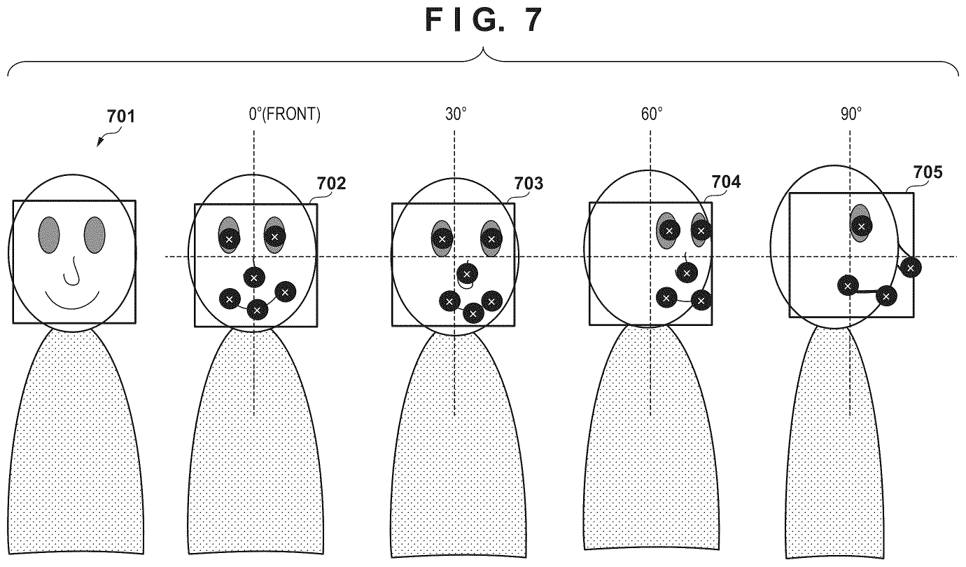

Specifically, as shown in FIG. 7, the subject state determination unit 117 sets feature point coordinates for important organs within the face area.

For example, in the case of a face 701 facing forward in FIG. 7, the positions of the eyes are located symmetrically with respect to the center line of a detected face area 702, the nose is located slightly below the center of the face area 702, and the mouth is located at the bottom of the face area 702 symmetrically with respect to the center line. In this case, the subject state determination unit 117 determines that the face is facing forward (face angle is) 0°. In a face area 703, the positions of the eyes and nose are all shifted slightly to the left compared to the face area 702, so the subject state determination unit 117 determines that the face angle is 30°. In a face area 704, the positions of the eyes and nose are further shifted to the left, so the angle is determined to be 60°, and in a face area 705, only one eye is detected, the nose is also located at the right edge of the face area 705, and the mouth is also located at the right side of the face area 705, so the angle is determined to be 90°. Note that the above angles shown in FIG. 7 are merely examples for indicating how much the face is facing to the side, and are not limited to these as long as the subject state determination unit 117 can ascertain the face direction.

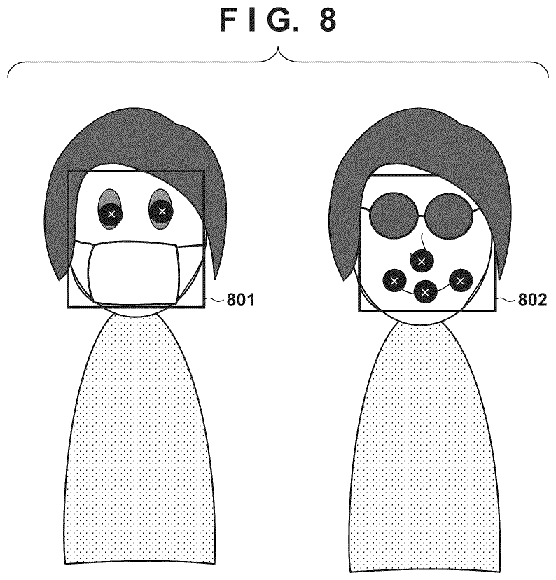

Further, the subject state determination unit 117 also determines presence or absence of an item such as a mask on the face based on the presence or absence of organ information. As shown in a face area 801 in FIG. 8, if only the eyes are detected as important organs in the face area 801 and the nose and mouth are covered by something other than skin, it is determined that the subject is wearing a mask. Further, as shown in a face area 802, if only the mouth and nose are detected as important organs in the face area 802 and the eyes are covered by something other than skin, it is determined that the subject is wearing sunglasses or glasses. As for the hair part, the subject state determination unit 117 determines whether or not there is an object with a color other than skin in the upper part of the head area, and classifies the hair into black hair, chestnut hair, blonde hair, red hair, white hair, etc. according to its color.

Next, in step S206, skin present in the live image is detected by the skin detection unit 118. Here, a detectable skin area is defined as human skin regardless of differences in skin color or brightness, and not only facial skin areas but also skin areas of hands and feet can be detected.

Next, in step S207, the subject state determination unit 117 determines whether the face is facing forward (frontal face) or sideways (profile face) based on the state of the subject determined in step S205. If the face is determined to be a frontal face or a profile face, the process proceeds to step S208, and if it is determined to be neither a frontal face nor a profile face, the process proceeds to step S213.

In this embodiment, the condition to determine a face as a profile face is that the angle of the face is within a range of about ±90° from the front position in the right and left directions. The range is assumed to guarantee a level at which a sufficient area for obtaining the luminance value of the skin area of the head area can be secured and exposure variation can be suppressed. If the angle exceeds 90°, it is determined that the area size of the skin area is not sufficient to obtain the luminance value.

In step S208, the luminance calculation unit 106 calculates an average skin luminance SkinY for the overlapping area between the face area detected in step S204 and the skin area detected in step S206. Here, a method for calculating the average skin luminance SkinY will be described with reference to examples shown in FIGS. 3A to 3D.

The luminance calculation unit 106 first determines in which of the divided blocks shown in the image 300a in FIG. 3B the face area detected by the subject detection unit 107 exists in the live image shown in FIG. 3A. In this case, a block area 301 in an image 301a in FIG. 3C corresponds to the face area.

Next, the luminance calculation unit 106 determines in which of the divided blocks shown in the image 300a in FIG. 3B the skin area detected by the skin detection unit 118 exists in the live image shown in FIG. 3A. In this case, a block area 302 in an image 302a in FIG. 3D corresponds to the skin area.

Then, the average skin luminance SkinY is calculated by averaging the luminance of blocks commonly included in the block area 301 and the block area 302. In the example shown in the block area 302 in a table 302b of FIG. 3D, the average value of 174, 168, 197, and 204, namely, 185.75, is obtained as the average skin luminance SkinY.

Here, if the number of blocks corresponding to the skin area is small, there is a concern that the average skin luminance SkinY may fluctuate. If the average skin luminance SkinY fluctuates, then the photometric value calculated later in step S210 will fluctuate, leading to fluctuation in the final exposure.

For this reason, the average skin luminance SkinY calculated may be one averaged over time. Specifically, the average value of the average skin luminance SkinY for the past N frames may be used. In other words, if the average skin luminance in the current frame Tis SkinY(T), then the calculation is as follows: average skin luminance SkinY=(SkinY(T)+SkinY(T−-1)+SkinY(T−2)+ . . . . SkinY(T−N−1))/N.

As another method, the previously calculated value may be used when the difference between the previously calculated value and the currently calculated value does not exceed a predetermined value. That is, if SkinY(T)−SkinY(T−1) is equal to or greater than a predetermined threshold, SkinY(T) is used, and if it is less than the threshold, SkinY(T−1) is used.

The process of suppressing the fluctuation in average skin luminance Skin Y may be performed only when the area size of the skin area is small. That is, if the area size of the skin area is less than TH1, the average value of average skin luminance SkinY for N frames is used, and if it is equal to or greater than TH1, the average skin luminance SkinY for the current frame calculated in step S208 is used.

Note that the method of suppressing the fluctuation in average skin luminance SkinY is not limited to the above method. By using these methods, the fluctuation in the photometric value can be suppressed and the exposure can be stabilized.

Next, in step S209, the luminance calculation unit 106 uses the average skin luminance SkinY to calculate the difference ΔBvFace from a predetermined target luminance value of the face. If the target luminance value is ReferenceY, the difference ΔBvFace can be calculated by using the following Equation (1):

ΔBvFace=LOG₂(SkinY/ReferenceY) (1)

Next, in step S210, the luminance calculation unit 106 uses the difference ΔBvFace to calculate the appropriate photometric value. If the photometric value calculated here is Bv, it is calculated using the following Equation (2).

Bv=CtrlBv+ΔBvFace +BvCorr (2)

Here, CtrlBv is the exposure value when the image was captured. In addition, BvCorr is a variety of correction values, including correction based on the degree of backlighting of the subject, correction based on the proportion of the sky which is a high-luminance area, night view correction, etc.

Thereafter, in step S211, the photometric value obtained in step S210 is stored for use when the face is facing other than forward or sideways.

The photometric value may be calculated further using the image luminance value obtained in step S203.

In a case where the image luminance value is further used, the photometric value Bv is calculated using the following Equation (3) instead of Equation (2).

Bv=(CtrlBv+ΔBvEa)×a+(CtrlBv+ΔBvFace)×b+BvCorr (3)

Here, ΔBvEa is the difference between the luminance value obtained from the image luminance value obtained in step S203 and the target luminance value. Furthermore, a and b are adjustment coefficients that determine the usage rate of the overall image luminance and the luminance of the skin area, and a+b=1.0.

By calculating the photometric value taking into account the image luminance value as described above, it is possible to control the exposure so that the brightness of not only the face but the entire image is appropriate.

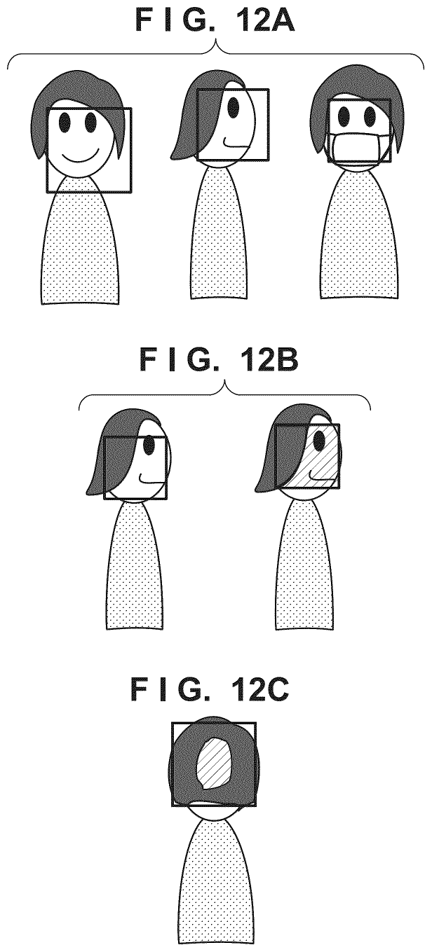

On the other hand, in step S207, if the orientation of the face is determined to be other than forward or sideways, and skin is detected due to the influence of the skin area underlying the hair as shown in FIG. 12C, for example, the photometric value is calculated for the hair area, which will result in overexposure in the case of black hair. To avoid this, in step S213, it is decided to use the photometric value stored in the step S211 most recently.

Then, in step S212, the exposure correction value calculation unit 119 calculates an exposure value based on the photometric value obtained in step S210 or S213, and feeds this back to the AE processing unit 109, which then performs convergence control to the appropriate exposure.

In this way, the exposure correction value calculation unit 119 calculates an exposure correction value for an area where the detected subject area and the detected skin area overlap in a case where the detected subject state is a frontal face or a profile face and the skin area is detected at a sufficient area size. On the other hand, if the detected subject state is not a frontal face or a profile face and the skin area is not detected at a sufficient area size, the stored photometric value is used.

In step S214, the control unit 102 determines whether SW1 is turned ON by operating the shutter switch included in the operation unit 101. If SW1 is not turned ON, the process returns to step S202, where a live image is acquired using the exposure value controlled in step S212, and the above process is repeated for the acquired live image.

When SW1 is turned ON in step S214, the final photometric value is acquired in step S215. At this time, the AF processing unit 108 also performs AF processing using the image information at this time point, and controls the lens 1081 so as to focus on the subject.

Then, in step S216, the control unit 102 determines whether SW2 is turned ON by operating the shutter switch. If SW2 is not turned ON, the process returns to step S214. If SW2 is turned ON, the process proceeds to step S217 to perform main exposure, where an electric charge corresponding to the light incident on the sensor unit 103 via the lens and exposure mechanism is read out, and an analog image signal corresponding to the electric charge is output to the A/D conversion unit 104.

The A/D conversion unit 104 performs sampling, gain adjustment, A/D conversion, etc. on the analog image signal output from the sensor unit 103 and outputs a digital image signal. The image processing unit 105 performs various image processing on the digital image signal and outputs the processed digital image signal.

The digital signal output from the image processing unit 105 is converted into a format such as JPEG by the encoder unit 112, and is output to the image recording unit 113. The image recording unit 113 performs recording the format-converted image data in a predetermined memory.

As described above, according to the first embodiment, the subject area, subject information, and skin area are acquired, and it is determined whether or not there is a sufficient amount of skin area secured. Then, by controlling the exposure so that the brightness of the facial skin area is appropriate, it is possible to control the exposure without being affected by the back of the head, items on the face, etc.

In the above example, the face direction is used to determine whether the state of the subject is such that the sufficient skin area can be secured, but the aspect of the embodiment is not limited to the face direction. The information on the face area, the whole body area, and the presence or absence of items such as a mask or sunglasses determined by the subject state determination unit 117 may be used comprehensively to perform the determination, for example, based on the area size of the face area or the face area obtained from the whole body area, or based on whether the subject is wearing a mask. Also, these determination methods may be combined to perform the determination.

### Second Embodiment

Next, a second embodiment will be described. In the second embodiment, exposure control in a state where the skin area cannot be sufficiently detected, such as not a frontal face, will be described.

### Configuration of an Image Capturing Apparatus

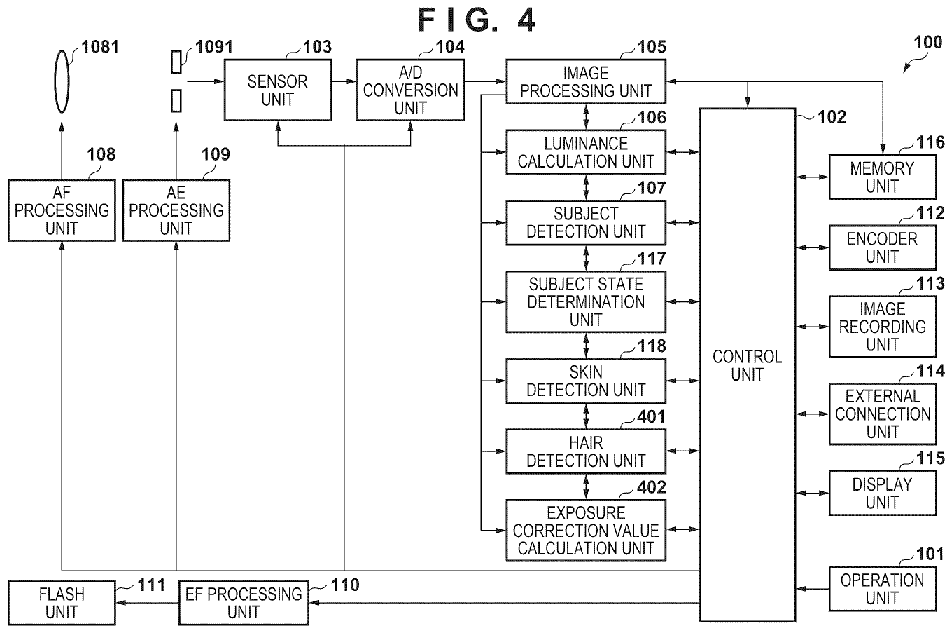

FIG. 4 is a block diagram illustrating the functional configuration of the image capturing apparatus 100 in the second embodiment. Note that in the configuration shown in FIG. 4, the same reference numerals are used for components similar to those shown in FIG. 1, and descriptions thereof will be omitted.

A hair detection unit 401 detects hair and beard in an image and acquires the area/areas. Hair detection can be performed using known methods such as a method of extracting an area of a color gamut within a predetermined range defined as hair color, a method using an algorithm that learns the hair area by machine learning, and a method of estimating the positions of hair and beard from a face detection area and extracting a pattern matching area. For example, in a method using machine learning, learning is performed by relating concepts of each granularity from the overall image of the object to the details as a hierarchical structure. When learning hair, images of people of various races, ages, and sexes are used for learning.

Based on the determination result of the subject state determination unit 117, an exposure correction value calculation unit 402 calculates an exposure correction value using an image signal of an area where the subject area (face area or head area) detected by the subject detection unit 107 is overlapped with the skin area detected by the skin detection unit 118 and the hair and beard area detected by the hair detection unit 401.

### Exposure Operation

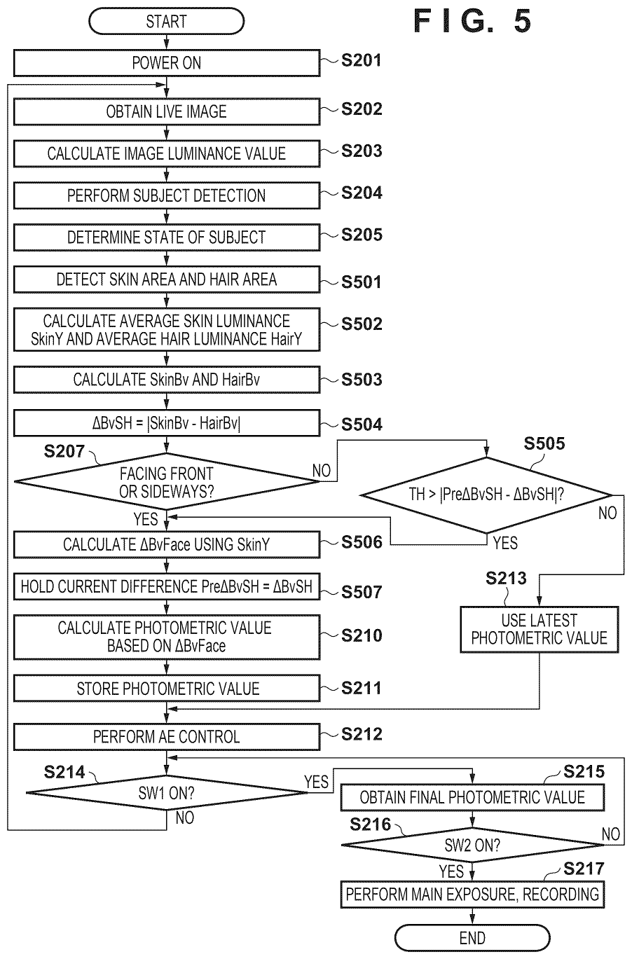

Next, exposure control in the second embodiment using the image capturing apparatus 100 having the above configuration will be described along with the flow of the shooting operation with reference to the flowchart in FIG. 5. However, the same steps as those in the first embodiment shown in FIG. 2 are given the same step numbers and will not be described as appropriate.

After calculating the luminance value of each block and the image luminance value (step S203), detecting the subject (step S204), and determining the state of the subject (step S205) based on the live image captured in step S202, in the next step S501, skin detection unit 118 detects a skin area present in the live image. Here, a detectable skin area refers to a person's skin regardless of skin color or brightness differences, and includes not only the skin area of the face, but also the skin areas of the hands and feet.

At the same time, the hair detection unit 401 detects the hair area present in the live image. Here, a detectable hair area refers to a person's hair and beard that can be detected regardless of race, age, or gender, and hair and beard are detected without relying on color information such as white hair, black hair, or red hair.

Then, in step S502, the luminance calculation unit 106 calculates average skin luminance SkinY for the overlapping area between the face area detected in step S204 and the skin area detected in step S501, as shown in FIGS. 3A to 3D. Similarly, the luminance calculation unit 106 calculates average hair luminance HairY for the overlapping area between the face area detected in step S204 and the hair area detected in step S501.

Then, in step S503, a skin Bv value SkinBv and hair Bv value HairBv are calculated from the average skin luminance SkinY and average hair luminance HairY calculated in step S502 and the target luminance value, and stored. If the exposure value at which the image was acquired is CtrlBv and the target luminance value is ReferenceY, the skin Bv value SkinBv and hair Bv value HairBv can be calculated using the following Equations (4).

SkinBv=CtrlBv+LOG₂(SkinY/ReferenceY)

HairBv=CtrlBv+LOG₂(HairY/ReferenceY) (4)

Next, in step S504, a luminance difference ΔBvSH between the skin and hair is calculated from the thus obtained skin Bv value SkinBv and the hair Bv value HairBv using the following Equation (5):

ΔBvSH=|SkinBv−HairBv| (5)

Next, in step S207, the subject state determination unit 117 determines whether the face is facing forward or sideways based on the state of the subject detected in step S205. If it is determined to be a frontal or profile face, the process proceeds to step S506, and if it is determined not to be a frontal or profile face, the process proceeds to step S505.

In step S506, the luminance calculation unit 106 calculates a difference ΔBvFace from the target luminance value of the face using the average skin luminance SkinY calculated in step S502. ΔBvFace is calculated based on the Equation (1).

Then, in step S507, the brightness difference ΔBvSH between the skin and hair calculated in step S504 is stored as a previous value preΔBvSH for the next time when it is determined that the face is other than a frontal face or a profile face.

Then, in step S210, the luminance calculation unit 106 calculates an appropriate photometric value using the difference ΔBvFace. A photometric value Bv is calculated based on the Equation (2). After that, in step S211, the photometric value obtained in step S210 is stored for when a face angle other than the frontal or profile face is detected.

On the other hand, if it is determined in step S207 that the face direction is not the forward or the sideways, the process proceeds to step S505. For example, as shown by 1206 in FIG. 12C, if the skin is detected due to the influence of the skin area that is the base of the hair in a state where the back of the head is determined, an inappropriate photometric value for the hair area may be calculated. In this case, the exposure for the hair area becomes unstable. To avoid this, it is determined whether the difference (amount of change) between the luminance difference ΔBvSH between the skin and the hair calculated in step S504 and the previous value PreΔBvSH is less than a predetermined threshold. If the difference is less than the predetermined threshold, the process proceeds to step S506, where the difference ΔBvFace is calculated using the average skin luminance SkinY calculated in step S502. If the difference is equal to or greater than the predetermined threshold, the process proceeds to step S213, where it is determined that the exposure value held in step S211 most recently is to be used. This makes it possible to suppress fluctuations in exposure.

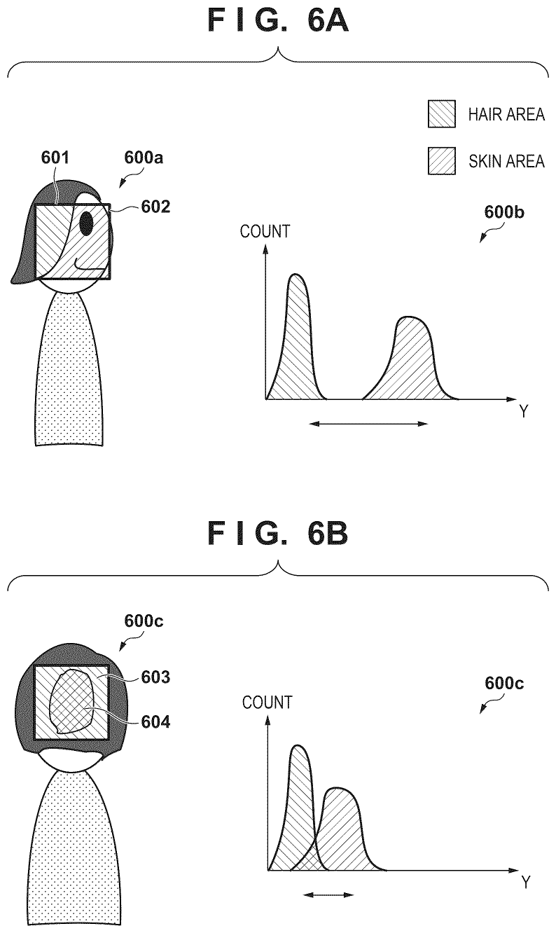

600a in FIG. 6A is a conceptual diagram showing an example of the subject area, skin area, and hair area detected when the face is facing sideways, and 600b is a conceptual diagram showing an example of the luminance distribution of the skin area and the luminance distribution of the hair area at this time. Also, 600c in FIG. 6B is a conceptual diagram showing an example of the subject area, skin area 604, and hair area 603 detected when the face is facing backwards, and 600d is a conceptual diagram showing an example of the luminance distribution of the skin area and the luminance distribution of the hair area at this time. It can be seen that when the face is facing backwards, the luminance distribution of the skin area 604 and the luminance distribution of the hair area 603 are closer than when the face is facing sideways. In other words, by comparing the previous luminance difference ΔBvSH with the luminance difference calculated this time, it is possible to determine whether or not the face direction has changed.

Then, in step S212, the exposure correction value calculation unit 119 calculates an exposure value based on the photometric value obtained in step S210 or S213, and feeds this back to the AE processing unit 109, which then performs convergence control to the appropriate exposure.

As described above, according to the second embodiment, the subject area, subject information, skin area, and hair area are acquired, and it is determined whether there is a sufficient amount of skin area and whether the external light environment is stable. Then, by controlling the exposure to be appropriate for the face, it is possible to set an appropriate exposure without being affected by the back of the head, wearing items, etc.

In the above-described first and second embodiments, the luminance value is calculated on a block-by-block basis. However, the aspect of the embodiments is not limited to this, and the luminance value may be calculated on a pixel-by-pixel basis.

### Third Embodiment

The third embodiment will be described below. In the third embodiment, the processing when the state of the subject indicates a frontal face or a profile face, but the skin area is small, will be described.

The configuration of an image capturing apparatus in the third embodiment is the same as that described in the first embodiment with reference to FIG. 1, so the description thereof will be omitted.

### Exposure Operation

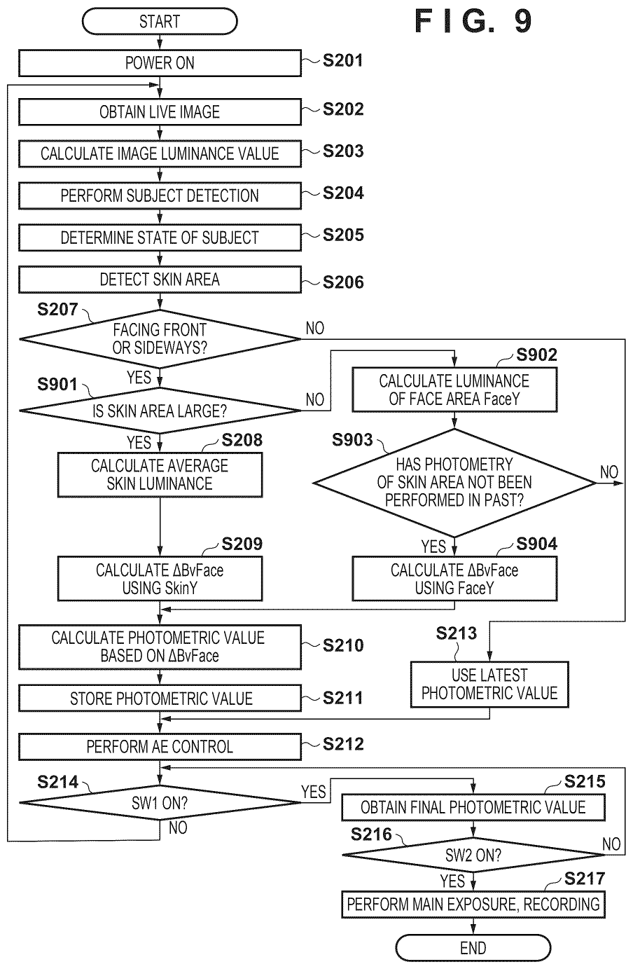

Next, exposure control in the third embodiment using the image capturing apparatus 100 will be described with reference to the flow chart in FIG. 9 along with the flow of the shooting operation. However, the same steps as those in the first embodiment shown in FIG. 2 are given the same step numbers, and the description thereof will be omitted as appropriate.

After calculation of the luminance value of each block and the image luminance value (step S203), subject detection (step S204), determination of the subject state (step S205), and skin area detection (step S206) are completed based on the live image captured in step S202, then in step S207, subject state determination unit 117 determines whether the face is facing forward or sideways based on the state of the subject detected in step S205. If it is determined to be a frontal or profile face, the process proceeds to step S901, and if it is determined to be neither a frontal nor profile face, the process proceeds to step S213.

In step S901, it is determined whether the area size of the skin area is large. In step S207, it is determined whether a skin area with a sufficient area size is secured to obtain the brightness of the skin area based on the condition of the face direction. However, even if the face is a frontal face or a profile face, if the face is small relative to the image, or in a scene where detection is difficult using a skin detection method using machine learning, the skin area may not be detected sufficiently. Therefore, in step S901, the area size of the skin area is evaluated in a case where it is determined to be a frontal face or a profile face. The area size evaluated here is specifically the number of blocks if the image is divided into blocks of a predetermined size, or the ratio of the number of blocks of the face or head area in the subject detected in step S204 to the number of blocks of the skin area. In step S901, it is determined whether the area size is equal to or larger than a predetermined threshold value TH. If it is determined to be equal to or larger than the threshold value TH, the process proceeds to step S208, and if it is determined to be less than the threshold value TH, the process proceeds to step S902.

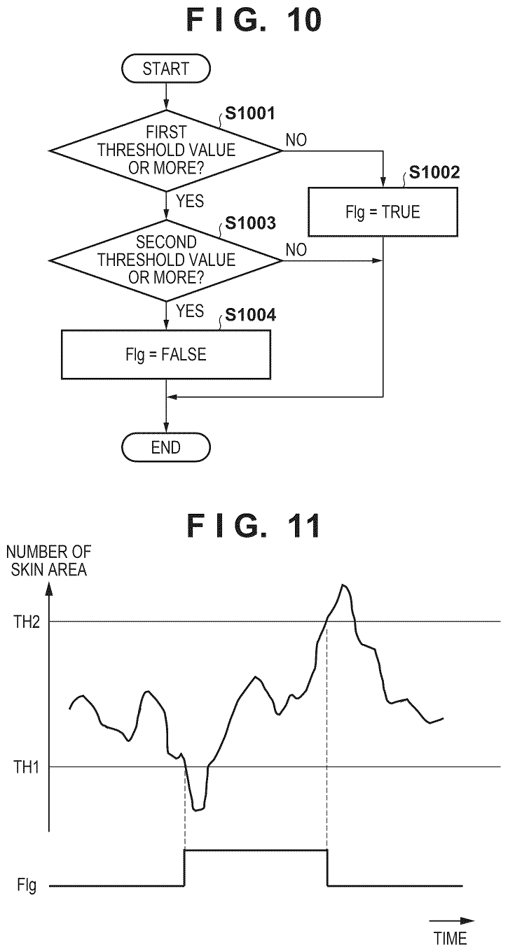

The determination in step S901 may be performed using a plurality of thresholds. Specifically, the determination is performed using a flag Flg as shown in FIG. 10 and FIG. 11. First, in step S1001, it is determined whether the area size of the skin area is equal to or larger than a first threshold TH1. If the area size is less than the first threshold TH1, Flg=True is set in step S1002. If the area size of the skin area is equal to or larger than the first threshold TH1 in the step S1001, it is determined in step S1003 whether the area size of the skin area is equal to or larger than a second threshold TH2. The second threshold TH2 is a predetermined threshold larger than the first threshold TH1. If the area size of the skin area is less than the second threshold TH2, the previous determination result is retained, and if the area size is equal to or larger than the second threshold TH2, Flg=False is set in step S1004. In this way, a flag is generated that becomes True in a case where the area size of the skin area falls below the first threshold TH1, and does not become False until it thereafter becomes equal to or greater than the second threshold TH2 that is greater than the first threshold TH1.

FIG. 11 is a diagram illustrating the area size of the skin area and the flag Flg with respect to time. The flag Flg is set to high when the area size of the skin area falls below the first threshold TH1, and then is set to a low when the area size of the skin area exceeds a second threshold TH2.

While the flag Flg is thus set, the determination in step S901 is NO, and if the flag Flg is not set, the determination in step S901 is YES.

This reduces variation in the photometric value by preventing the luminance calculation method from being changed more frequently than when switching between calculating the photometric value using the luminance of the skin area or using the luminance of the face area with the single threshold value in the judgment in step S901 in FIG. 9.

In addition, there is a concern that the determination result may vary due to variations in the skin detection method using machine learning in determining the area size of the skin area in step S901. As a result, whether the photometric value is calculated using the luminance of the skin area or the luminance of the face area is frequently changed, leading to fluctuation of the photometric value.

Therefore, the area size of the skin area may be averaged over time. Specifically, the area sizes of the skin area for N frames are averaged. More specifically, if the area size of the skin area in the current frame T is SkinNum(T), the area size of the skin area is calculated as SkinNum=(SkinNum(T−1)+SkinNum(T−2)+. . . SkinNum(T−1))/N.

As another method, the previously calculated value may be used in a case where the difference from the previously calculated value does not exceed a predetermined value. More specifically, SkinNum(T) is used if SkinNum(T)−SkinNum(T−1) is equal to or greater than a predetermined threshold, and SkinNum(T−1) is used if it is less than the threshold.

Note that the method of suppressing the variation in SkinY is not limited to the above method.

This prevents frequent changes in the determination in step S901 of FIG. 9 as to whether the photometric value is calculated using the luminance of the skin area or the luminance of the face area, thereby reducing variation in the photometric value.

If it is determined in step S901 that the skin area is small, the luminance Face Y of the face area is calculated in step S902. The face area is that the face area detected in step S204. Next, in step S903, it is determined whether or not photometry of the skin area of the subject to be detected has been performed in the past. The photometry of the skin area refers to the calculation of a photometric value using the average skin luminance SkinY calculated in step S208. In step S208, in this embodiment, the photometry calculation is performed using the luminance of the skin area only for a face that is a frontal face or a profile face and whose skin area having the area size of equal to or greater than the threshold value TH is detected. If the photometry of the skin area has not been performed in the past, there is no stored photometric value supposed to be calculated in step S210 performed most recently. In that case, the process proceeds to step S904, and the luminance FaceY of the face area calculated in step S902 is used to calculate a difference ΔBvFace from a predetermined target luminance value of the face. The difference ΔBvFace is calculated based on an equation in which SkinY in the Equation (1) is replaced with FaceY.

Next, in step S210, the luminance calculation unit 106 uses the difference ΔBvFace to calculate an appropriate photometric value Bv. The photometric value Bv is calculated based on the Equation (2).

In addition, when calculating the photometric value, the brightness of the face area is used, so compared to the skin area, there is a possibility that the face area may include items such as a mask or sunglasses, or a hair area. For example, if the face area includes a part of a white mask, the photometric value is higher than the luminance of the skin area, so the final exposure is darker than when the luminance of the skin area is used. On the other hand, when the face area includes sunglasses, the photometric value is lower than the brightness of the skin area, so the final exposure is brighter than when the luminance of the skin area is used. Similarly, in photometry using a face frame surrounding a profile face, the photometric value is calculated darker due to the inclusion of the hair area, so the final exposure is brighter than when the luminance of the skin area is used. In consideration of the above,, the contribution of the difference ΔBvFace when calculating the photometric value in step S210 is reduced.

Specifically, the following Equation (6) is used instead of the Equation (2) to calculate the photometric value.

Bv=(CtrlBv+ΔBvFace)×k+BvCorr (6)

Here, k is a coefficient ranging from 0 to 1.0. When the luminance of the face area is used, the contribution of the difference ΔBvFace to the photometric value Bv is reduced. On the other hand, when the luminance of the skin area SkinY is used, the contribution of the difference ΔBvFace is not reduced. Therefore, in step S209, k is set to k1, and in step S904, k is set to k2. Here, k1 and k2 are predetermined values that satisfy a condition of k1 >k2 and, for example, k1 =1.0, k2 =0.5. With the above process, the influence of the luminance of the face area is reduced when performing photometry of the face area compared to when performing photometry of the skin area, so that the influence of items such as masks and sunglasses and hair on the photometric value can be reduced.

As another method for suppressing the effect of the difference ΔBvFace, a value included in the exposure correction value BvCorr may be controlled. For example, the backlight correction value AlphaCorr, which is one type of exposure correction value BvCorr, is calculated as follows:

AlphaCorr=(ΔBvFace−ΔBvEa)×α (7)

The backlight correction value AlphaCorr is a correction amount obtained by calculating the degree of backlighting of the subject from the difference ΔBvFace between the luminance of the face area and the target value, and the difference ΔBvEa between the overall luminance and the target value and is to be applied to the photometric value. α is a coefficient that adjusts how much of the degree of backlighting is to be reflected in the photometric value. Instead of k, which is directly applied to the difference ΔBvFace described above, the value of α may be changed depending on whether the photometric value is calculated using the luminance of the skin area or the luminance of the face area.

Thereafter, in step S211, the photometric value obtained in step S210 is stored for the case where the face is facing other than front or sideways and the area size of the skin area is small.

The photometric value may be calculated further using the image luminance value calculated in step S203. By calculating the photometric value taking into account the image luminance value, it is possible to control the exposure so that the brightness of the entire image, not just the face, is appropriate. In this case, the photometric value Bv is calculated based on the following Equation (8) which adds the coefficient k used in the Equation (6) to the Equation (3).

Bv=(CtrlBv+ΔBvEa)×a+(CtrlBv+ΔBvFace)×b×k+BvCorr (8)

In step S207, if the direction of the face is other than forward or sideways, or in step S903, if photometry of the skin area has been performed in the past, i.e., if a photometric value calculated in step S210 exists, the process proceeds to step S213, and it is decided to use the photometric value held in step S211 performed most recently.

Then, in step S212, the exposure correction value calculation unit 119 calculates an exposure value based on the photometric value obtained in step S210 or S213, and feeds this back to the AE processing unit 109, which then performs convergence control to the appropriate exposure.

As described above, according to the third embodiment, in a scene where it is difficult to detect a skin area and there is concern about variations in the photometric value using the luminance of the skin area, the luminance of the face area is used, thereby a stable photometric calculation can be performed. Furthermore, if a skin area of a sufficient area size is detected and the luminance of the skin area can be used, the photometric value of the skin area obtained most recently can be used, so that an appropriate exposure can be calculated using the skin area.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-030642, filed Feb. 29, 2024, and No. 2024-104357, filed Jun. 27, 2024, which are hereby incorporated by reference herein in their entirety.

What is claimed is:

1. An image processing apparatus comprising at least one processor or circuit configured to function as:
an acquisition unit that acquires an image
a first detection unit that detects a first area showing a subject included in the image;
a second detection unit that detects a second area having a predetermined first characteristic included in the image;
a determination unit that determines a state of the subject;
a calculation unit that calculates a photometric value using a luminance value of a first overlapping area in which the first area and the second area overlap in a case where the determination unit determines that the state of the subject satisfies a predetermined condition; and
a decision unit that decides an exposure value based on the photometric value.

2. The image processing apparatus according to claim 1, wherein, in a case where the determination unit determines that the state does not satisfy the condition, the decision unit decides the exposure value using a photometric value most recently determined.

3. The image processing apparatus according to claim 1, wherein, in a case where the determination unit determines that the state does not satisfy the condition, the decision unit decides the exposure value using a photometric value calculated using a luminance value of the first area.

4. The image processing apparatus according to claim 3, wherein in a case of calculating the photometric value using the luminance value of the first area, the calculation unit reduces a contribution of the luminance value of the first area to the photometric value.

5. The image processing apparatus according to claim 1, wherein the at least one processor or circuit further functions as a third detection unit that detects a third area having a predetermined second characteristic different from the first characteristic included in the image, and
in a case where the determination unit determines that the state of the subject does not satisfy the predetermined condition, if an amount of change in a difference between the luminance value of the first overlapping area and a luminance value of a second overlapping area in which the first area and the third area overlap is less than a predetermined threshold, the decision unit decides the exposure value using the photometric value, and if the amount of change in the difference is equal to or greater than a predetermined threshold, the decision unit decides the exposure value using a photometric value most recently calculated by the calculation unit.

6. The image processing apparatus according to claim 5, wherein the subject is a human face, and the area having the second characteristic is hair and a beard.

7. The image processing apparatus according to claim 1, wherein the condition is a condition regarding the size of the second area included in the subject.

8. The image processing apparatus according to claim 7, wherein
a predetermined first threshold value related to the size of the second area and a predetermined second threshold value larger than the first threshold value are provided, and
the determination unit does not change a determination result of the condition until the size of the second area becomes equal to or greater than the second threshold value after the size of the second area becomes less than the first threshold value.

9. The image processing apparatus according to claim 7, wherein the determination unit determines the condition based on an average value of the sizes of a predetermined number of the second areas obtained in the past.

10. The image processing apparatus according to claim 7, wherein the determination unit performs the determination based on the condition based on the amount of change in the size of the second area most recently obtained.

11. The image processing apparatus according to claim 7, wherein the size of the second area is the ratio of the second area to the first area.

12. The image processing apparatus according to claim 1, wherein the subject is a human face, and the state of the subject includes at least one of the face direction, the presence or absence and type of a worn item, and the presence or absence and color of beard and hair.

13. The image processing apparatus according to claim 12, wherein the condition is that a face direction is within a range of a predetermined angle from the front.

14. The image processing apparatus according to claim 1, wherein the calculation unit calculates the photometric value based on a difference between the luminance value of the first overlapping area and a predetermined target luminance value.

15. The image processing apparatus according to claim 1, wherein the subject is a human face, and the area having the first characteristic is skin.

16. An electronic apparatus comprising:
an image processing apparatus comprising at least one processor or circuit configured to function as:
an acquisition unit that acquires an image;
a first detection unit that detects a first area showing a subject included in the image;
a second detection unit that detects a second area having a predetermined first characteristic included in the image;
a determination unit that determines a state of the subject;
a calculation unit that calculates a photometric value using a luminance value of a first overlapping area in which the first area and the second area overlap in a case where the determination unit determines that the state of the subject satisfies a predetermined condition; and
a decision unit that decides an exposure value based on the photometric value;
an image shooting unit that shoots and outputs an image; and
at least one processor or circuit configured to function as a control unit that controls exposure based on the exposure value decided by the decision unit.

17. An image processing method comprising:
acquiring an image;
detecting a first area showing a subject included in the image;
detecting a second area having a predetermined first characteristic included in the image;
determining a state of the subject;
calculating a photometric value using a luminance value of a first overlapping area in which the first area and the second area overlap in a case where it is determined that the state of the subject satisfies a predetermined condition; and
deciding an exposure value based on the photometric value.

18. The image processing method according to 17, further comprising detecting a third area having a predetermined second characteristic different from the first characteristic included in the image,
wherein, in a case where it is determined that the state of the subject does not satisfy the predetermined condition, if an amount of change in a difference between a luminance value of the first overlapping area and a luminance value of a second overlapping area in which the first area and the third area overlap is less than a predetermined threshold, the exposure value is decided using the photometric value, and if the amount of change in the difference is equal to or greater than a predetermined threshold, the exposure value is decided using a photometric value most recently calculated.

19. A non-transitory computer-readable storage medium, the storage medium storing a program that is executable by the computer, wherein the program includes program code for causing the computer to function as an image processing apparatus comprising:
an acquisition unit that acquires an image;
a first detection unit that detects a first area showing a subject included in the image;
a second detection unit that detects a second area having a predetermined first characteristic included in the image;
a determination unit that determines a state of the subject;
a calculation unit that calculates a photometric value using a luminance value of a first overlapping area in which the first area and the second area overlap in a case where the determination unit determines that the state of the subject satisfies a predetermined condition; and
a decision unit that decides an exposure value based on the photometric value.
